(19) United States
(12) Patent Application Publication
(10) Pub. No.: US 2012/0077030 A1
(43) Pub. Date: Mar. 29, 2012

(54) MULTISTAGE PREPARATION OF AQUEOUS PRESSURE-SENSITIVE ADHESIVE DISPERSIONS FOR PRODUCING SELF-ADHESIVE ARTICLES

(75) Inventors: Matthias Gerst, Maikammer (DE); Gerhard Auchter, Bad Duerkheim (DE); Michael Groß, Mannheim (DE); Daniel Wilms, Alzey (DE); Roelof Balk, Boehl-lggelheim (DE)

(73) Assignee: BASF SE, Ludwigshafen (DE)

(21) Appl. No.: 13/237,621

(22) Filed: Sep. 20, 2011

Related U.S. Application Data
(60) Provisional application No. 61/385,580, filed on Sep. 23, 2010.

(51) Int. Cl. C09J 7/02; C09J 121/02; B05D 5/10; C09J 151/06

(52) U.S. Cl. 428/355 AC; 524/458; 524/460; 428/355 EN; 427/208.4

(57) ABSTRACT

Described is a process for preparing an aqueous pressure-sensitive adhesive dispersion from ethylenically unsaturated, free-radically polymerizable monomers. In a first stage, a first polymer is prepared by free-radical emulsion polymerization. In a second stage, an aqueous polymer dispersion is prepared in the presence of the first polymer, where the glass transition temperature calculated for a polymer prepared from the monomers of the second stage is less than −20° C. The monomers of the first stage comprise monomers with acid groups. The polymerization of the first stage takes place at a low pH of less than 5. The acid groups of the first polymer are neutralized during, or before and during, the polymerization of the second stage to an extent such that the pH of the polymer dispersion at the end of the second stage is greater than 5. The aqueous pressure-sensitive adhesive dispersions can be used for producing self-adhesive articles, especially self-adhesive labels and adhesive tapes.

The invention relates to a process for preparing an aqueous pressure-sensitive adhesive dispersion from ethylenically unsaturated, free-radically polymerizable monomers, where, in a first stage, a first polymer is prepared by free-radical emulsion polymerization. In a second stage, an aqueous polymer dispersion is prepared in the presence of the first polymer. The monomers of the first stage comprise monomers with acid groups. The polymerization of the first stage takes place at a relatively low pH and the acid groups of the first polymer are neutralized only after the first stage, either during, or before and during, the polymerization of the second stage. The aqueous pressure-sensitive adhesive dispersions can be used for producing self-adhesive articles.

With pressure-sensitive adhesives (PSAs) there is a desire not only for effective adhesion to the substrate but also for sufficient cohesion (internal strength) within the layer of adhesive. Adhesion and cohesion are divergent performance properties. Measures which bring about an improvement in adhesion generally lead at the same time to a deterioration in cohesion, and vice versa. PSAs based on aqueous polymer dispersions which are obtainable by emulsion polymerization have been known for a long time. They include, more particularly, polyacrylates. In general they are copolymers in which at least one of the monomers is an acrylic ester which forms polymers having a relatively low glass transition temperature. In the case of PSA dispersions prepared by emulsion polymerization with the use of relatively large amounts of emulsifier, the adhesive bonding values may be adversely affected by the relatively high emulsifier content automatically present. Without emulsifier, or with significantly reduced amounts of emulsifier, there may be instances of instability of the dispersion or there may be increased formation of coagulum. The implementation of emulsion polymerization substantially without emulsifiers as well is known in principle, if protective colloids are used instead of the emulsifiers. Typical protective colloids are polymers which contain acid groups and which are water-soluble at elevated pH levels when the acid groups are neutralized. At these elevated pH levels and at the temperatures, which typically are elevated, at which emulsion polymerizations are carried out, however, there may be unwanted side reactions in the form of hydrolysis of the acrylate esters. The by-products which form to a small extent in such reactions may, in turn, adversely affect the adhesive bonding properties of the PSAs.

The object was to provide aqueous PSA dispersions having as small an emulsifier content as possible, having good adhesion and cohesion, and forming as little coagulum as possible.

It has been found that the object can be achieved by the preparation process elucidated in more detail below and by the polymer dispersions obtainable by said process. The invention provides a process for preparing an aqueous PSA dispersion,
where initially in a first stage in aqueous medium a first polymer dispersed in water is prepared by free-radical emulsion polymerization, the first polymer being prepared from a first composition comprising ethylenically unsaturated, free-radically polymerizable monomers, and where
subsequently in a second stage a polymer dispersion is prepared in aqueous medium and in the presence of the first polymer by free-radical emulsion polymerization of a second composition, which is different from the first composition and comprises ethylenically unsaturated, free-radically polymerizable monomers,
where the monomers of the first stage comprise at least one monomer with at least one acid group, in an amount of at least 0.1 part by weight, based on the total amount of monomers of the first and second stages, and
where the polymerization of the first stage takes place at a pH less than 5, preferably less than or equal to 4.5, and, either during the polymerization of the second stage or before and during the polymerization of the second stage, the acid groups of the first polymer are neutralized to an extent such that the pH of the polymer dispersion at the end of the second stage is greater than 5, preferably greater than or equal to 5.5; and
where the glass transition temperature calculated for a polymer prepared from the monomers of the second stage is less than −20° C.

A PSA is a viscoelastic adhesive whose set film at room temperature (20° C.) in a dry state remains permanently tacky and adhesive. Adhesive bonding to substrates is accomplished instantaneously under gentle pressure. An aqueous PSA dispersion is a composition which comprises a polymer which is in dispersion in water or in aqueous medium and which has pressure-sensitive adhesive properties.

The process described encompasses the preparation of polyacrylate dispersions for application as PSAs, by a specially adapted “one-pot” process which is based on the stabilization of emulsion polymers by protective colloids, or amphiphilic polymers or oligomers which can act like protective colloids, that are formed in situ, i.e., during the emulsion polymerization.

The principle of the process of the invention is based on the preferably seed-controlled formation of small polymer particles in aqueous dispersion in a first polymerization stage by free-radical polymerization of a first monomer composition comprising at least one ethylenically unsaturated monomer with at least one acid group (e.g., a mixture of alkyl(meth)acrylate, (meth)acrylic acid, and optionally further monomers) and also subsequent neutralization of the acid groups. This neutralization of the acid groups takes place either partly before and partly parallel with the supply and polymerization of a second monomer composition (e.g., a mixture of alkyl acrylate and optionally further monomers) in a second polymerization stage. Or the neutralization of the acid groups takes place completely parallel with the supply and polymerization of the second monomer composition in the second polymerization stage. Following neutralization, the particles formed in the first stage are able to act like protective colloids and to stabilize the polymer dispersion of the invention. At the beginning of the reaction of the first stage, the pH in the reaction vessel falls continually as a result of continuous addition of acid and initiator. As a result of this, the polymer particles formed in the first polymerization stage are undissolved. Only with increasing neutralization during the second polymerization stage (e.g., by addition of ammonia) does the hydrophilic character of the first-stage polymer particles increase, these particles being able to act like dispersion-stabilizing amphiphilic protective colloids in the emulsion polymerization which begins with addition of the principal monomers of the second stage, since they are composed preferably of apolar alkyl(meth)acrylate units and polar (meth)acrylic acid units.

The invention also provides aqueous PSA dispersions prepared by the process of the invention, the use of the aqueous PSA dispersions of the invention for producing self-adhesive articles, self-adhesive articles produced using a PSA comprising an aqueous polymer dispersion of the invention, and a corresponding process for producing self-adhesive articles.

The polymer dispersions prepared in accordance with the invention are obtainable by free-radical emulsion polymerization of ethylenically unsaturated compounds (monomers). The polymerization both of the first stage and of the second stage takes place preferably with no emulsifier or with little emulsifier in the sense that no or less than 1% by weight of emulsifier is added to stabilize the polymer dispersion of the invention. Emulsifiers are nonpolymeric, amphiphilic, surface-active substances that are added to the polymerization mixture. Small amounts of emulsifiers, present as a result, for example, of the use of emulsifier-stabilized polymer seed, are not detrimental. It is preferred that, in total, less than 1% or less than 0.5% by weight of emulsifier is used, more particularly less than 0.4% by weight or less than 0.3% by weight, based on solids content of the polymer dispersion, or no emulsifier.

In the first stage a polymer is prepared from monomers which comprise at least one monomer with at least one acid group, in an amount of at least 0.1 part by weight, preferably from 0.5 to 10 parts by weight, based on the total amount of monomers of the first and second stages. Preferably, in the first stage, monomers containing acid groups (acid monomers) are copolymerized with monomers without acid groups, more particularly nonionic monomers. The weight ratio of monomers containing acid groups to monomers without acid groups in the monomer mixture of the first polymerization stage is preferably in the range from 0.5:99.5 to 30:70, preferably from 1:99 to 20:80 or from 2:98 to 15:85.

At low pH levels of 2 to 3, for example, and with non-neutralized acid groups, the polymer of the first stage is not water-soluble, but is dispersed in water. If neutralizing agent is added during, or before and during, the polymerization of the second stage, there is a successive increase, with increasing degree of neutralization of the acid groups, in the hydrophilicity and water-solubility of the polymer of the first stage. With increasing hydrophilicity and water-solubility, the polymer of the first stage is able increasingly to act as a protective colloid for the polymer of the second stage and, toward the end of the polymerization, is able to stabilize the polymer dispersion with high polymer solids content. Protective colloids are polymeric compounds which, on solvation, bind large amounts of water and are capable of stabilizing dispersions of water-insoluble polymers. The number-average molecular weight of the protective colloids is preferably above 1000 g/mol, more particularly above 2000 g/mol, and preferably up to 50 000 g/mol or up to 10 000 g/mol. As for example from 1000 to 100 000 g/mol, from 1000 to 10 000 g/mol or from 2000 to 10 000 g/mol.

The polymers of the first stage that become effective as protective colloids on neutralization are used preferably in an amount of 1% to 60% or of 5% to 50% by weight, or of 7% to 40% or of 10% to 30% by weight (particularly when the total solids content of the polymer dispersion of the invention is more than 50% by weight), based on 100% by weight of the monomers to be polymerized.

The acid groups of the polymer of the first stage may be neutralized partially or completely with suitable bases. It is preferred to use aqueous sodium hydroxide or potassium hydroxide solution, or ammonia, as neutralizing agent.

The acid monomers used in the first stage can be copolymerized with monomers without acid group. The polymer of the first stage is preferably formed from at least 40% by weight of nonionic principal monomers, defined in more detail below, and also from a second kind of monomer, selected from ethylenically unsaturated acid monomers. The polymer of the first stage may, furthermore, optionally be formed from further, preferably nonionic, monomers. The polymer of the first stage is preferably composed of at least 40%, more particularly of 60% to 99% or of 80% to 98%, by weight, based on all the monomers of the first stage, of principal monomers which are selected from the group consisting of C1 to C20 alkyl(meth)acrylates, vinyl esters of carboxylic acids comprising up to 20C atoms, vinylaromatics having up to 20C atoms, ethylenically unsaturated nitriles, vinyl halides, vinyl ethers of alcohols comprising 1 to 10C atoms, aliphatic hydrocarbons having 2 to 8C atoms and one or two double bonds, and mixtures of these monomers. Principal monomers for the polymer of the first stage are, for example, (meth)acrylic acid alkyl esters with a C₁-C₁₀ alkyl radical, such as methyl methacrylate, methyl acrylate, n-butyl acrylate, ethyl acrylate, and 2-ethylhexyl acrylate. Also suitable in particular are mixtures of the (meth)acrylic acid alkyl esters. Vinyl esters of carboxylic acids having 1 to 20C atoms are, for example, vinyl laurate, vinyl stearate, vinyl propionate, Versatic acid vinyl esters, and vinyl acetate. Vinylaromatic compounds contemplated include vinyltoluene, alpha- and para-methylstyrene, alpha-butylstyrene, 4-n-butylstyrene, 4-n-decylstyrene, and, preferably, styrene. Examples of nitriles are acrylonitrile and methacrylonitrile. The vinyl halides are ethylenically unsaturated compounds substituted by chlorine, fluorine or bromine, preferably vinyl chloride and vinylidene chloride. Vinyl ethers include, for example, vinyl methyl ether and vinyl isobutyl ether. Vinyl ethers of alcohols comprising 1 to 4C atoms are preferred. As hydrocarbons having 4 to 8C atoms and two olefinic double bonds, mention may be made of butadiene, isoprene, and chloroprene. Preferred as principal monomers for the polymer of the first stage are C1 to C10 alkyl acrylates, C1 to C10 alkyl methacrylates, vinyl esters of carboxylic acids comprising up to 20C atoms, and mixtures of these monomers, more particularly C₁ to C₈ alkyl acrylates and C₁ to C₈ alkyl methacrylates and vinyl esters. Especially preferred are 2-ethylhexyl acrylate, butyl acrylate, methyl methacrylate, and vinyl acetate.

The polymer of the first stage is further composed, preferably, of at least 1%, more particularly of 1% to 40% or of 2% to 20%, by weight of ethylenically unsaturated acid monomers, based on all the monomers of the first stage. Ethylenically unsaturated acid monomers are, for example, ethylenically unsaturated carboxylic acids, ethylenically unsaturated sulfonic acids, and vinylphosphonic acid. Ethylenically unsaturated carboxylic acids used are preferably alpha,beta-monoethylenically unsaturated monocarboxylic and dicarboxylic acids having 3 to 6C atoms in the molecule. Examples thereof are acrylic acid, methacrylic acid, itaconic acid, maleic acid, fumaric acid, crotonic acid, vinylacetic acid, vinyllactic acid, and 2-carboxyethyl acrylate. Examples of suitable ethylenically unsaturated sulfonic acids include vinylsulfonic acid, styrenesulfonic acid, acrylamidomethylpropanesulfonic acid, sulfopropyl acrylate, and sulfopropyl methacrylate. Preference is given to acrylic acid and methacrylic acid and a mixture thereof, and acrylic acid is particularly preferred.

In one preferred embodiment the polymer of the first stage is a copolymer which
(i) is used in an amount of 5% to 50% by weight, based on 100 parts by weight of the total monomers to be polymerized in the first and second stages,
(ii) is composed of at least 80% and up to 99% by weight of principal monomers which are selected from the group consisting of C1 to C10 alkyl(meth)acrylates, vinyl esters of carboxylic acids comprising up to 20C atoms, and mixtures of these monomers, more particularly 2-ethylhexyl acrylate, n-butyl acrylate, methyl methacrylate, and vinyl acetate, and
(iii) is composed of at least 1% and up to 20% by weight of ethylenically unsaturated acid monomers, which are preferably selected from acrylic acid, methacrylic acid, and a mixture thereof.

One embodiment of the invention uses at least one molecular weight regulator in the polymerization of the first stage. By means of such a regulator it is possible to reduce the molar mass of the emulsion polymer, by a chain termination reaction. The regulators are attached in the process to the polymer, generally to the chain end. The amount of regulators is in particular 0.05 to 4 parts by weight, more preferably 0.05 to 0.8 part by weight, and very preferably 0.1 to 0.4 part by weight, based on 100 parts by weight of the monomers to be polymerized. Examples of suitable regulators include compounds having a thiol group such as tert-butyl mercaptan, thioglycolic alkyl ester, mercaptoethanol, mercaptopropyltrimethoxysilane or tert-dodecyl mercaptan. The regulators are generally low molecular weight compounds with a molar weight of less than 2000, more particularly less than 1000 g/mol.

In one preferred embodiment of the invention, the polymerization of the first stage takes place in the presence of seed latex. Seed latex is an aqueous dispersion of finely divided polymer particles having an average particle diameter of preferably 20 to 40 nm. Seed latex is used in an amount of preferably 0.05% to 5% by weight, more preferably of 0.1% to 3% by weight, based on the total monomer amount of the first and second stages. A suitable latex, for example, is one based on polystyrene or based on polymethyl methacrylate. A preferred seed latex is polystyrene seed.

Preferably at least 60%, more preferably at least 80%, e.g., from 80% to 100%, more preferably at least 90% or 100%, by weight of the monomers used for the polymerization of the second stage, based on the total amount of the monomers of the second stage, comprise one or more of the principal monomers described below. The principal monomers are selected from the group consisting of C₁-C₂₀ alkyl(meth)acrylates, vinyl esters of carboxylic acids comprising up to 20C atoms, vinylaromatics having up to 20C atoms, ethylenically unsaturated nitriles, vinyl halides, vinyl ethers of alcohols comprising 1 to 10C atoms, aliphatic hydrocarbons having 2 to 8C atoms and one or two double bonds, or mixtures of these monomers.

Examples include (meth)acrylic acid alkyl esters with a C₁-C₁₀ alkyl radical, such as methyl methacrylate, methyl acrylate, n-butyl acrylate, ethyl acrylate, and 2-ethylhexyl acrylate. Also suitable in particular are mixtures of the (meth)acrylic acid alkyl esters. Vinyl esters of carboxylic acids having 1 to 20C atoms are, for example, vinyl laurate, vinyl stearate, vinyl propionate, Versatic acid vinyl esters, and vinyl acetate. Vinylaromatic compounds contemplated include vinyltoluene, alpha- and para-methylstyrene, alpha-butylstyrene, 4-n-butylstyrene, 4-n-decyl-styrene, and, preferably, styrene. Examples of nitriles are acrylonitrile and methacrylonitrile. The vinyl halides are ethylenically unsaturated compounds substituted by chlorine, fluorine or bromine, preferably vinyl chloride and vinylidene chloride. Vinyl ethers include, for example, vinyl methyl ether and vinyl isobutyl ether. Vinyl ethers of alcohols comprising 1 to 4C atoms are preferred. As hydrocarbons having 4 to 8C atoms and two olefinic double bonds, mention may be made of butadiene, isoprene, and chloroprene.

Preferred as principal monomers for the polymerization of the second stage are the C₁ to C₁₀ alkyl acrylates and C₁ to C₁₀ alkyl methacrylates, more particularly C₁ to C₈ alkyl acrylates and C₁ to C₁₀ alkyl methacrylates, and vinylaromatics, especially styrene, and mixtures thereof. Very particular preference is given to methyl acrylate, methyl methacrylate, ethyl acrylate, n-butyl acrylate, n-hexyl acrylate, octyl acrylate, 2-ethylhexyl acrylate, 2-propylheptyl acrylate, styrene, vinyl acetate, and mixtures of these monomers.

Besides the principal monomers, the monomers for the polymerization of the second stage may comprise further monomers, examples being monomers with carboxylic acid, sulfonic acid or phosphonic acid groups. Carboxylic acid groups are preferred. Examples include acrylic acid, methacrylic acid, itaconic acid, maleic acid, and fumaric acid. Further monomers are also, for example, monomers comprising hydroxyl groups, especially C₁-C₁₀ hydroxyalkyl(meth)acrylates, and also (meth)acrylamide. Further monomers that may be mentioned are, moreover, phenyloxyethylglycol mono(meth)acrylate, glycidyl acrylate, glycidyl methacrylate, and amino(meth)acrylates such as 2-aminoethyl(meth)acrylate. Crosslinking monomers are further monomers that may also be mentioned. The monomers used in the second stage preferably comprise less than 2% by weight of or no monomers with acid groups.

In particular, the monomers for the polymerization of the second stage are selected, to an extent of at least 60%, more preferably at least 80%, e.g., from 60% to 100%, and very preferably at least 95% or 100%, by weight, from at least one C₁ to C₂₀ alkyl acrylate, at least one C₁ to C₂₀ alkyl methacrylate, a mixture thereof, or a mixture thereof with at least one further monomer selected from styrene, vinyl acetate, and C₁-C₁₀ hydroxyalkyl acrylates.

In one embodiment, the monomer with at least one acid group that is used in the first stage is acrylic acid; the monomers without an acid group that are used in the first stage are selected from 2-ethylhexyl acrylate, n-butyl acrylate, methyl acrylate, methyl methacrylate, vinyl acetate, and a mixture thereof; and at least 80% by weight of the monomers used in the second stage are selected from the group consisting of C1 to C10 alkyl acrylates, C1 to C10 alkyl methacrylates, vinyl acetate, styrene, and a mixture thereof.

The monomers of the polymerization in the second stage are selected such that the glass transition temperature, calculated for a polymer prepared from the monomers of the second stage, is less than −20° C., more particularly in the range from −60° C. to −30° C. or in the range from −55° C. to −35° C. By controlled variation of the nature and amount of the monomers it is possible in accordance with the invention for the skilled person to prepare aqueous polymer compositions whose polymers have a glass transition temperature within the desired range. Guidance is possible by means of the Fox equation. According to Fox (T. G. Fox, Bull. Am. Phys. Soc. 1956 [Ser. II] 1, page 123, and in accordance with Ullmann's Encyclopädie der technischen Chemie, Volume 19, page 18, 4th Edition, Verlag Chemie, Weinheim, 1980), the calculation of the glass transition temperature of copolymers is subject in good approximation to the following equation:

1/T_{g}=x¹/T_{g}¹+x²/T_{g}²+ . . . xⁿ/T_{g}ⁿ,

where x¹, x², . . . xⁿ are the mass fractions of the monomers 1, 2, . . . n and T_{g}¹, T_{g}², . . . T_{g}ⁿ are the glass transition temperatures of the polymers synthesized in each case only from one of the monomers 1, 2, . . . n, in degrees Kelvin. The T_{g} values for the homopolymers of the majority of monomers are known and are listed in, for example, Ullmann's Ecyclopedia of Industrial Chemistry, Vol. 5, Vol. A21, page 169, VCH Weinheim, 1992; other sources of glass transition temperatures of homopolymers include, for example, J. Brandrup, E. H. Immergut, Polymer Handbook, 1st Edition, J. Wiley, New York 1966, 2nd Edition, J. Wiley, New York 1975, and 3rd Edition, J. Wiley, New York 1989. For ethyl acrylate a figure of −13° C. is used.

The actual glass transition temperature of the polymer in the polymer dispersion of the invention (first and second stages) is preferably in the range from −55° C. to −30° C. The actual glass transition temperature may be determined by means of differential scanning calorimetry (ASTM D 3418-08, midpoint temperature).

The weight ratio of the amount of the monomers used in the first stage to the amount of the monomers used in the second stage is preferably from 5:95 to 50:50 or from 5:95 to 40:60, more preferably from 10:90 to 30:70.

The polymer dispersion of the invention is prepared by emulsion polymerization. In the emulsion polymerization, ethylenically unsaturated compounds (monomers) are polymerized in water, with the use typically of ionic and/or nonionic emulsifiers and/or protective colloids or stabilizers as interface-active compounds for stabilizing the monomer droplets and the polymer particles subsequently formed from the monomers. In accordance with the invention, however, both the polymerization of the first stage and the polymerization of the second stage take place with little emulsifier or wholly or virtually without emulsifier. It is preferred to use a total of less than 1% or less than 0.5% by weight, more particularly less than 0.4% by weight or less than 0.3% by weight, of emulsifier, based on solids content of the polymer dispersion, or no emulsifier. For the stabilization of the polymer dispersion formed in the polymerization of the second stage, the polymer of the first stage is used, which is converted in situ, by addition of neutralizing agent, from a water-insoluble polymer which is not active as a protective colloid into a water-soluble polymer which is active as a protective colloid.

The neutralization of acid groups of the first polymer takes place preferably by at least partial feed addition of a neutralizing agent during the polymerization of the second stage, the feed of neutralizing agent taking place preferably in parallel with the monomer feed. The neutralizing agent may be added in a joint feed with the monomers to be polymerized, or in a separate feed. After all of the monomers have been fed in, the amount of neutralizing agent present in the polymerization vessel is preferably the amount needed to neutralize at least 10%, preferably 30% to 100% or 30% to 90%, of acid equivalents.

The emulsion polymerization of the first and second stages may be started using water-soluble initiators. Water-soluble initiators are, for example, ammonium salts and alkali metal salts of peroxodisulfuric acid, e.g., sodium peroxodisulfate, hydrogen peroxide, or organic peroxides, e.g., tert-butyl hydroperoxide. Also suitable as initiators are what are called reduction-oxidation (redox) initiator systems. The redox initiator systems are composed of at least one, usually inorganic, reducing agent and one organic or inorganic oxidizing agent. The oxidizing component comprises, for example, the emulsion polymerization initiators already stated above. The reducing component comprises, for example, alkali metal salts of sulfurous acid, such as, for example, sodium sulfite, sodium hydrogen sulfite, alkali metal salts of disulfurous acid such as sodium disulfite, bisulfite addition compounds of aliphatic aldehydes and ketones, such as acetone bisulfite, or reducing agents such as hydroxymethanesulfinic acid and its salts, or ascorbic acid. The redox initiator systems may be used in conjunction with soluble metal compounds whose metallic component is able to occur in a plurality of valence states. Typical redox initiator systems are, for example, ascorbic acid/iron(II) sulfate/sodium peroxydisulfate, tert-butyl hydroperoxide/sodium disulfite, and tert-butyl hydroperoxide/Na hydroxymethanesulfinic acid. The individual components, the reducing component for example, may also be mixtures, an example being a mixture of the sodium salt of hydroxymethanesulfinic acid with sodium disulfite.

The stated initiators are used mostly in the form of aqueous solutions, with the lower concentration being determined by the amount of water that is acceptable in the dispersion, and the upper concentration by the solubility of the respective compound in water. Generally speaking, the concentration of the initiators is 0.1% to 30%, preferably 0.2% to 20%, more preferably 0.3% to 10%, by weight, based on the monomers to be polymerized. It is also possible for two or more different initiators to be used in the emulsion polymerization.

The molecular weight regulators stated above may be used in the polymerization of the second stage. Preferably, however, the polymerization of the second stage takes place without addition of further molecular weight regulators.

The emulsion polymerization takes place in general at 30 to 130° C., preferably at 50 to 90° C. The polymerization medium may be composed of water alone, or of mixtures of water and water-miscible liquids such as methanol. It is preferred to use just water. The emulsion polymerization of the first stage may be carried out either as a batch operation or in the form of a feed process, including staged or gradient procedures. For more effective setting of the particle size it is preferred, in the polymerization, to include a polymer seed in the initial charge.

The way in which the initiator is added to the polymerization vessel in the course of the free-radical aqueous emulsion polymerization is known to a person of ordinary skill in the art. It may be included in its entirety in the initial charge to the polymerization vessel, or introduced, continuously or in stages, at the rate at which it is consumed in the course of the free-radical aqueous emulsion polymerization. In each individual case, this will depend on the chemical nature of the initiator system and on the polymerization temperature. It is preferred to include a portion in the initial charge and to supply the remainder to the polymerization zone at the rate of its consumption. For the purpose of removing the residual monomers, it is customary to add initiator after the end of the actual emulsion polymerization as well, i.e., after a monomer conversion of at least 95%. The individual components may be added to the reactor, in the case of the feed process, from above, in the side or from below, through the reactor bottom.

The emulsion polymerization produces aqueous polymer dispersions having solids contents generally of 15% to 75%, preferably of 40% to 75%, and more preferably of greater than or equal to 50%, by weight. For a high space/time yield of the reactor, dispersions with a very high solids content are preferred. In order to be able to attain solids contents >60% by weight, a bimodal or polymodal particle size ought to be set, since otherwise the viscosity becomes too high and the dispersion can no longer be handled. Producing a new generation of particles can be accomplished, for example, by adding seed (EP 81083), by adding excess amounts of emulsifier, or by adding miniemulsions. A further advantage associated with the low viscosity at high solids content is the improved coating behavior at high solids contents. Producing one or more new generations of particles can be done at any desired point in time. This point in time is guided by the particle size distribution that is aimed at for a low viscosity.

The polymer prepared in this way is used preferably in the form of its aqueous dispersion. The size distribution of the dispersion particles may be monomodal, bimodal or multimodal. In the case of a monomodal particle size distribution, the average particle size of the polymer particles dispersed in the aqueous dispersion is preferably less than 500 nm, more particularly less than 400 nm. By average particle size here is meant the d₅₀ of the particle size distribution, i.e., 50% by weight of the total mass of all the particles have a particle diameter smaller than the d₅₀. The particle size distribution can be determined in a known way using the analytical ultracentrifuge (W. Mächtle, Makromolekulare Chemie 185 (1984), pages 1025-1039). In the case of a bimodal or multimodal particle size distribution, the particle size may be up to 1000 nm. The pH of the polymer dispersion is set preferably to a pH of more than 5, more particularly to a pH between 5.5 and 8.

A pressure-sensitive adhesive of the invention comprises the PSA polymers preferably in the form of the aqueous polymer dispersion as obtained or obtainable by the emulsion polymerization. The PSAs may be composed solely of the polymers or of the aqueous dispersion of the polymers. Alternatively, the PSA may also comprise other adjuvants, examples being fillers, dyes, flow control agents, thickeners, preferably associative thickeners, defoamers, plasticizers, pigments, wetting agents or tackifiers (tackifying resins). Tackifiers are known, for example, from Adhesive Age, July 1987, page 19-23 or Polym. Mater. Sci. Eng. 61 (1989), page 588-592. For improved surface wetting, the PSAs may comprise, in particular, wetting assistants, examples being fatty alcohol ethoxylates, alkylphenol ethoxylates, nonylphenol ethoxylates, polyoxyethylenes/propylenes, dialkyl esters of sulfonated dicarboxylic acids, or sodium dodecylsulfonates. The amount of adjuvants is generally 0.05 to 5 parts by weight, more particularly 0.1 to 3 parts by weight, per 100 parts by weight of polymer (solid).

Tackifiers are, for example, natural resins, such as rosins and their derivatives formed by disproportionation or isomerization, polymerization, dimerization, hydrogenation. They may be present in their salt form (with, for example, monovalent or polyvalent counterions (cations) or, preferably, in their esterified form. Alcohols used for the esterification may be monohydric or polyhydric. Examples are methanol, ethanediol, diethylene glycol, triethylene glycol, 1,2,3-propanetriol, pentaerythritol. Also used, furthermore, are hydrocarbon resins, examples being coumarone-indene resins, polyterpene resins, hydrocarbon resins based on unsaturated CH compounds, such as butadiene, pentene, methylbutene, isoprene, piperylene, divinylmethane, pentadiene, cyclopentene, cyclopentadiene, cyclohexadiene, styrene, a-methylstyrene, vinyltoluene. Also in increasing use as tackifiers are polyacrylates which have a low molar weight. Preferably these polyacrylates have a weight-average molecular weight M_{w} of below 30 000. The polyacrylates are preferably composed to an extent of at least 60%, more particularly at least 80%, by weight of C₁-C₈ alkyl(meth)acrylates. Preferred tackifiers are natural or chemically modified rosins. Rosins are composed predominantly of abietic acid or derivatives of abietic acid. The tackifiers can be added to the polymer dispersion in a simple way. Preferably the tackifiers are themselves in the form of an aqueous dispersion. The amount by weight of the tackifiers is preferably 5 to 100 parts by weight, more preferably 10 to 50 parts by weight, based on 100 parts by weight of polymer (solid/solid).

The PSA dispersion of the invention can be used for producing self-adhesive articles. The self-adhesive articles are obtainable by coating a carrier material at least partly with the PSA dispersion. The self-adhesive articles are preferably removable again after bonding. The self-adhesive articles may be, for example, sheets, tapes or labels. Suitable carrier materials are, for example, paper, polymeric films, and metal foils. Self-adhesive tapes of the invention may be single-sidedly or double-sidedly coated tapes made from the above substances. Particular preference is given to self-adhesive labels. Self-adhesive labels of the invention may be labels of paper or of a thermoplastic film. Thermoplastic films contemplated include, for example, films of polyolefins (e.g., polyethylene, polypropylene), polyolefin copolymers, films of polyesters (e.g., polyethylene terephthalate), or polyacetate. The surfaces of the thermoplastic polymer films are preferably corona-treated. The labels are coated on one side with adhesive. Preferred substrates for the self-adhesive articles are paper and polymer films. Particularly preferred self-adhesive articles are paper labels.

The self-adhesive articles are coated at least partly on at least one surface with a pressure-sensitive adhesive of the invention. The adhesive may be applied by typical methods such as rolling, knife coating or spreading onto the articles. Use may be made of typical coating techniques, examples being roller coating, reverse roller coating, gravure roller coating, reverse gravure roller coating, brush coating, rod coating, spray coating, airbrush coating, meniscus coating, curtain coating or dip coating. The coat weight is preferably 0.1 to 30 g, more preferably 2 to 20 g, of solid per m². Application is generally followed by a drying step for removing the water and/or the solvents. The water can be removed by drying at, for example, 50 to 150° C. The coated substrates obtained in this way are used, for example, as self-adhesive articles, such as labels, adhesive tapes or sheets. For this purpose, before or after the application of the adhesive, the carriers can be cut to form adhesive tapes, labels or sheets. For later use, the PSA-coated side of the substrates may be lined with a release paper—with a siliconized paper, for example.

The substrates to which the self-adhesive articles may advantageously be applied may be composed, for example, of metal, wood, glass, paper or plastic. The self-adhesive articles are suitable more particularly for bonding to packaging surfaces, boxes, plastic packaging, books, windows, motor vehicle bodies or bodywork parts.

The present invention also provides a process for producing self-adhesive articles which uses an aqueous PSA dispersion of the invention. In this context, the aqueous PSA dispersions may be used as they are or after formulation with the typical auxiliaries referred to above. In the process for producing self-adhesive articles, the aqueous PSA dispersion of the invention is applied to and dried on a carrier material which is preferably selected from paper and polymeric films.

Particular advantages of the preparation process of the invention and of the products of the invention are the following especially:
improved cohesion and/or adhesion in comparison to conventionally prepared PSA dispersions
reduction in coagulum content in comparison to conventionally prepared PSA dispersions
it is possible to operate with little emulsifier or virtually no emulsifier (small amounts of emulsifier when using an emulsifier-stabilized polymer seed are not detrimental)
simplicity of the process (no need for metered addition of initiator)
cost saving in comparison to other polymer dispersions stabilized by protective colloid, since the preparation of the protective colloid in situ removes the need for separate synthesis, transport, and storage of the protective colloid
extensive variability of the process in terms of the composition of the protective colloid that can be used (polymer of the first stage) and also of the overall composition of the polymer dispersion.

### EXAMPLES

### Example B1

In a reaction vessel with anchor stirrer, the vessel being heated at 85° C., 19.7 g of polystyrene seed dispersion (content: 33%, particle size=30 nm) and 430 g of fully demineralized water are introduced. Then 111 g of sodium peroxodisulfate solution (7% strength in water) are added and the system is stirred at 85° C. for 3 minutes. This is followed by the addition of monomer feed 1 over the course of 40 minutes. After 10-minute post-polymerization of the first polymerization stage, partial neutralization is performed using 6.2 g of ammonia (25% strength in water) in 25 g of fully demineralized water. The second polymerization stage is then started, by commencing monomer feed 2 and adding it over the course of 90 minutes. 40 minutes after the commencement of monomer feed 2, neutralization is performed by running 7.8 g of ammonia (25% strength in water) in 31 g of fully demineralized water into the system over the course of 10 minutes. Thereafter, additionally 13 g of tert-butyl hydroperoxide and 16.9 g of acetone bisulfite are added, and the system is cooled and filtered.

Solids content 54%; pH 5.6

Monomer Feed 1:

| | |
|---|---|
| 74 g | water |
| 1.63 g | Disponil ® FES 77 (fatty alcohol ether sulfate, sodium |
| | salt, 32-34% strength aqueous solution) |
| 1.16 g | Dowfax ® 2A1 (alkyldiphenyl oxide disulfonate, |
| | 45% strength aqueous solution) |
| 13 g | acrylic acid |
| 20.8 g | methyl methacrylate |
| 205.4 g | 2-ethylhexyl acrylate |
| 1.95 g | 2-ethylhexyl thioglycolate |

Monomer Feed 2:

| | |
|---|---|
| 304 g | water |
| 6.5 g | Disponil ® FES 77 |
| 4.62 g | Dowfax ® 2A1 |
| 20.8 g | 2-hydroxypropyl acrylate |
| 20.8 g | styrene |
| 62.4 g | vinyl acetate |
| 936 g | 2-ethylhexyl acrylate |

### Examples B2-B6

Polymerization as in Example B1, using the monomer feeds 1 and 2 listed in Tables 1 and 2, in a weight ratio of 20:80, based on the monomers.

TABLE 1
Monomer feed 1 (figures in parts by weight)

| | B1 | B2 | B3 | B4 | B5 | B6 |
|---|---|---|---|---|---|---|
| 2-Ethylhexyl acrylate | 79 | 79 | | 79 | 79 | 79 |
| n-Butyl acrylate | | | 79 | | | |
| Methyl methacrylate | 8 | 8 | 8 | 8 | 8 | 8 |
| Vinyl acetate | 8 | 8 | | 8 | 8 | 8 |
| Methyl acrylate | | | 8 | | | |
| Acrylic acid | 5 | 5 | 5 | 5 | 5 | 5 |
| 2-Ethylhexyl thioglycolate | 0.15 | 0.15 | 0.15 | 0.15 | 0.15 | — |
| Disponil ® FES 77 | 0.1 | — | 0.1 | 0.1 | 0.1 | 0.1 |
| Dowfax ® 2A1 | 0.1 | — | 0.1 | 0.1 | 0.1 | 0.1 |
| Tg [° C.] | −38.5 | −38.5 | −25.6 | −38.5 | −38.5 | −38.5 |

TABLE 2
Monomer feed 2 (figures in parts by weight)

| | B1 | B2 | B3 | B4 | B5 | B6 |
|---|---|---|---|---|---|---|
| 2-Ethylhexyl acrylate | 90 | 90 | 90 | 89 | 79 | 90 |
| Vinyl acetate | 6 | 6 | 6 | 6 | 10 | 6 |
| Styrene | 2 | 2 | 2 | 2 | — | 2 |
| 2-Hydroxypropyl acrylate | 2 | 2 | 2 | 2 | — | 2 |
| Methyl methacrylate | | | | | 10 | |
| Acrylic acid | | | | 1 | 1 | |
| Disponil ® FES 77 | 0.1 | | | 0.1 | 0.1 | 0.1 |
| Dowfax ® 2A1 | 0.1 | | | 0.1 | 0.1 | 0.1 |
| Tg [° C.] | −50.9 | −50.9 | −50.9 | −49.8 | −39.4 | −50.9 |

Comparative Polymer Dispersion C1 to C6

Preparation took place in the same way as for B1 to B6, the difference being that the polymerization was carried out in one stage, i.e., a mixture of monomer feed 1 and monomer feed 2 was added, in each case as a single, joint monomer feed, over the course of 130 minutes.

The dispersions were investigated for formation of coagulum. The results are reported in Table 3.

TABLE 3
Coagulum formation, figures in g

| | B1 | C1 | B2 | C2 | B3 | C3 | B4 | C4 | B5 | C5 | B6 | C6 |
|---|---|---|---|---|---|---|---|---|---|---|---|---|
| Coagulum | 10 | 50 | 18 | 25 | 14 | 30 | 5 | 10 | 5 | 10 | 5 | 15 |

Performance Testing:

The PSAs were coated with a coat weight of 19 g/m² onto Hostaphan® RN 36 (biaxially oriented polyethylene terephthalate film, 36 μm thick) as carrier, and dried. Then the peel strength (adhesion) and the shear strength (cohesion) were determined.

The PSA-coated carrier was cut into test strips 25 mm wide. For determination of the shear strength, the test strips were adhered to steel with an adhered area of 25×25 mm, rolled down once with a roller weighing 1 kg, stored for 10 minutes (under standard conditions, 50% relative humidity, 1 bar, 23° C.), and then loaded in suspension with a 1 kg weight (under standard conditions). The measure of the shear strength was the time taken, in minutes, for the weight to fall off; in each case the average was calculated from 5 measurements.

In the determination of the peel strength (adhesion), one 25 mm wide test strip in each case was adhered to a test body made of polyethylene and was rolled down once with a roller weighing 1 kg. The test strip was then clamped by one end into the upper jaws of a tensile strain testing apparatus. The adhesive strip was peeled from the test surface at an angle of 180° and at 300 mm/min—that is, the strip of adhesive was bent around and pulled off parallel to the test body, and the expenditure of force required to achieve this was recorded. The measure of the peel strength was the force in N/25 mm which was obtained as the average value from five measurements. The peel strength was determined 24 hours after bonding. After this time, the bond strength has developed fully. The test methods correspond substantially to Finat Test Methods (FTM) 1 and 8. The results are set out in Table 4.

TABLE 4
Test results for peel strength and shear strength

| | Peel strength on PE | Shear strength on |
|---|---|---|
| Example | [N/25 mm] | steel [min] |
| B1 | 8.2 | 60 |
| C1 | 4.0 | 8 |
| B2 | 6.9 | 20 |
| C2 | 4.5 | 4 |
| B3 | 11.7 | 6 |
| C3 | 3.7 | 1 |
| B4 | 14.8 | 551 |
| C4 | 7.1 | 29 |
| B5 | 5.0 | >1000 |
| C5 | 5.0 | 213 |
| B6 | 13.0 | 2100 |
| C6 | 13.0 | 1666 |

The inventive examples each exhibit, relative in each case to the direct comparative example, a significantly increased shear strength (cohesion), with the adhesion remaining at least the same. Examples B1 to B4 each exhibit, relative to the direct comparative example in each case, a significantly increased peel strength (adhesion).

We claim:

1. A process for preparing an aqueous pressure-sensitive adhesive dispersion,
where initially in a first stage in aqueous medium a first polymer dispersed in water is prepared by free-radical emulsion polymerization, the first polymer being prepared from a first composition comprising ethylenically unsaturated, free-radically polymerizable monomers, and where
subsequently in a second stage a polymer dispersion is prepared in aqueous medium and in the presence of the first polymer by free-radical emulsion polymerization of a second composition, which is different from the first composition and comprises ethylenically unsaturated, free-radically polymerizable monomers,
where the monomers of the first stage comprise at least one monomer with at least one acid group, in an amount of at least 0.1 part by weight, based on the total amount of monomers of the first and second stages, and
where the polymerization of the first stage takes place at a pH less than 5 and, either during the polymerization of the second stage or before and during the polymerization of the second stage, the acid groups of the first polymer are neutralized to an extent such that the pH of the polymer dispersion at the end of the second stage is greater than 5;
and
where the glass transition temperature calculated for a polymer prepared from the monomers of the second stage is less than −20° C.

2. The process according to the preceding claim, wherein a total of less than 1.0% by weight of emulsifier, based on solids content of the polymer dispersion, or no emulsifier is used.

3. The process according to either of the preceding claims, wherein, in the first stage, monomers containing acid groups are copolymerized with monomers without acid groups, the weight ratio of monomers containing acid groups to monomers without acid groups being in the range from 2:98 to 15:85.

4. The process according to any of the preceding claims, wherein the monomers with at least one acid group that are used in the first stage are selected from the group consisting of acrylic acid, methacrylic acid, itaconic acid, maleic acid, fumaric acid, crotonic acid, vinylacetic acid, vinyllactic acid, 2-carboxyethyl acrylate, vinylsulfonic acid, styrenesulfonic acid, acrylamidomethylpropanesulfonic acid, sulfopropyl acrylate, sulfopropyl methacrylate, and mixtures of these monomers; and the monomers without acid group that are used in the first stage are selected from the group consisting of C1 to C10 alkyl acrylates, C1 to C10 alkyl methacrylates, vinyl esters of carboxylic acids comprising up to 20C atoms, and mixtures of these monomers.

5. The process according to any of the preceding claims, wherein at least 60% by weight of the monomers used in the second stage are selected from the group consisting of C1 to C20 alkyl acrylates, C1 to C20 alkyl methacrylates, vinyl esters of carboxylic acids comprising up to 20C atoms, vinylaromatics having up to 20C atoms, ethylenically unsaturated nitriles, vinyl halides, vinyl ethers of alcohols comprising 1 to 10C atoms, aliphatic hydrocarbons having 2 to 8C atoms and one or two double bonds, and mixtures of these monomers.

6. The process according to any of the preceding claims, wherein the monomer with at least one acid group that is used in the first stage is acrylic acid;
and wherein the monomers without acid groups that are used in the first stage are selected from 2-ethylhexyl acrylate, n-butyl acrylate, methyl acrylate, methyl methacrylate, vinyl acetate, and a mixture thereof;
and wherein at least 80% by weight of the monomers used in the second stage are selected from the group consisting of C1 to C10 alkyl acrylates, C1 to C10 alkyl methacrylates, vinyl acetate, styrene, and a mixture thereof.

7. The process according to any of the preceding claims, wherein the glass transition temperature calculated for a polymer prepared from the monomers of the second stage is in the range from −60° C. to −30° C.

8. The process according to any of the preceding claims, wherein a molecular weight regulator is used in the polymerization of the first stage.

9. The process according to any of the preceding claims, wherein the weight ratio of the amount of the monomers used in the first stage to the amount of the monomers used in the second stage is from 5:95 to 50:50.

10. The process according to any of the preceding claims, wherein the polymerization of the first stage takes place in the presence of a seed latex.

11. The process according to any of the preceding claims, wherein the neutralization of acid groups of the first polymer takes place at least partly by feed addition of a neutralizing agent during the polymerization of the second stage.

12. The process according to any of the preceding claims, wherein the monomers used in the second stage comprise less than 2% by weight of or no monomers with acid groups.

13. An aqueous pressure-sensitive adhesive dispersion prepared by the process according to any of the preceding claims.

14. The use of the aqueous pressure-sensitive adhesive dispersion according to the preceding claim for producing self-adhesive articles.

15. A self-adhesive article obtainable by coating a carrier material with a pressure-sensitive adhesive dispersion according to claim 13.

16. The self-adhesive article according to the preceding claim, which is a self-adhesive label, an adhesive sheet or an adhesive tape.

17. A process for producing self-adhesive articles, which comprises providing an aqueous pressure-sensitive adhesive dispersion according to claim 13 and applying it to and drying it on a carrier material selected from paper and polymeric films.
